(19) United States
(12) Patent Application Publication
(10) Pub. No.: US 2016/0019009 A1
(43) Pub. Date: Jan. 21, 2016

(54) Automatic Speed Adjustment of a Printing Device

(71) Applicant: Neuralog, L.P., Stafford, TX (US)

(72) Inventor: Kenneth P. Land, Sugar Land, TX (US)

(21) Appl. No.: 14/336,083

(22) Filed: Jul. 21, 2014

(51) Int. Cl. G06F 3/12

(52) U.S. Cl. CPC G06F 3/1215; G06F 3/1253

(57) ABSTRACT

The present invention relates to an automatic calibration of a printing apparatus. A system for calibrating a printing device includes a media having at least one predetermined attribute and an attribute detector for detecting the attribute. The attribute detector may automatically detect the attribute of the media as the media is moved through the printing device. The attribute detector may provide instructions for adjusting the printing speed of the printing device in dependence on the detected attribute.

### FIELD OF THE INVENTION

The present invention relates to an automatic calibration of a printing apparatus. In particular, the invention relates to the automatic speed adjustment of a printer.

### SUMMARY

In one embodiment, a computer-implemented method for automatically calibrating a printing device is disclosed. The method may be performed by an attribute detector. The attribute detector may include a computer processor connected to a memory. The method includes automatically detecting an attribute of a media as the media is moved through a media path of the printing device; and adjusting the printing speed of the printing device in dependence on the detected attribute.

In another embodiment, a non-transitory computer-readable storage medium storing computer program instructions for calibrating a printing device is disclosed. The storage medium includes computer program instructions for automatically detecting an attribute of a media as the media is moved through the printing device; and computer program instructions for adjusting the printing speed of the printing device in dependence on the detected attribute.

In yet another embodiment, a system for calibrating a printing device includes a media having at least one attribute and an attribute detector. The attribute detector may include a processor and a memory communicatively linked to the processor. The memory may store computer program instructions executable by the processor. The attribute detector may include computer program instructions for automatically detecting the attribute of the media as the media is moved through the printing device; and computer program instructions for adjusting the printing speed of the printing device in dependence on the detected attribute.

The attribute may include a plurality of predetermined markings. Each of the markings may be located on a surface of the media. The method may further involve generating the plurality of predetermined markings on the surface of the media. At least a first predetermined marking and a second predetermined marking may be spaced apart at a preselected interval.

The actual printing speed of the printing device may be determined by the attribute detector. The actual printing speed may correspond to an actual time required to travel between the first predetermined marking and the second predetermined marking.

The actual printing speed may be compared by the processor with a desired printing speed. The desired printing speed may be predetermined prior to, during or after the media is fed through the media path of the printing device.

If the actual printing speed of the printing device does not match the desired printing speed, the actual printing speed can be incrementally modified until it substantially matches the desired printing speed. The processor can automate the adjustment of the actual printing speed of the printing device.

These and other embodiments of the invention are described in detail with reference to the following drawing

### BRIEF DESCRIPTION OF THE FIGURES

FIG. 1 depicts a system for calibrating a printing device according to one embodiment of the invention.

FIG. 2 depicts a flow diagram for calibrating a printing device according to one embodiment of the invention.

FIG. 3 depicts a flow diagram for calibrating a printing device according to one embodiment of the invention.

### DETAILED DESCRIPTION OF THE INVENTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. A computer readable storage medium may be a transitory or a non-transitory medium, for example, but not limited to, an electronic, magnetic, optical, electromagnetic, infrared, or semiconductor system, apparatus, or device, or any suitable combination of the foregoing. More specific examples (a non-exhaustive list) of non-transitory computer readable storage media include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute as a stand-alone software package and partly or entirely on a printing device.

An embodiment of the present invention may be implemented by computer program instructions. These computer program instructions may be provided to a processor of a printing device or other programmable data processing apparatus to produce instructions which execute via the processor of the printing device. These computer program instructions may also be stored in a computer readable medium that can direct a printing device to function in a particular manner.

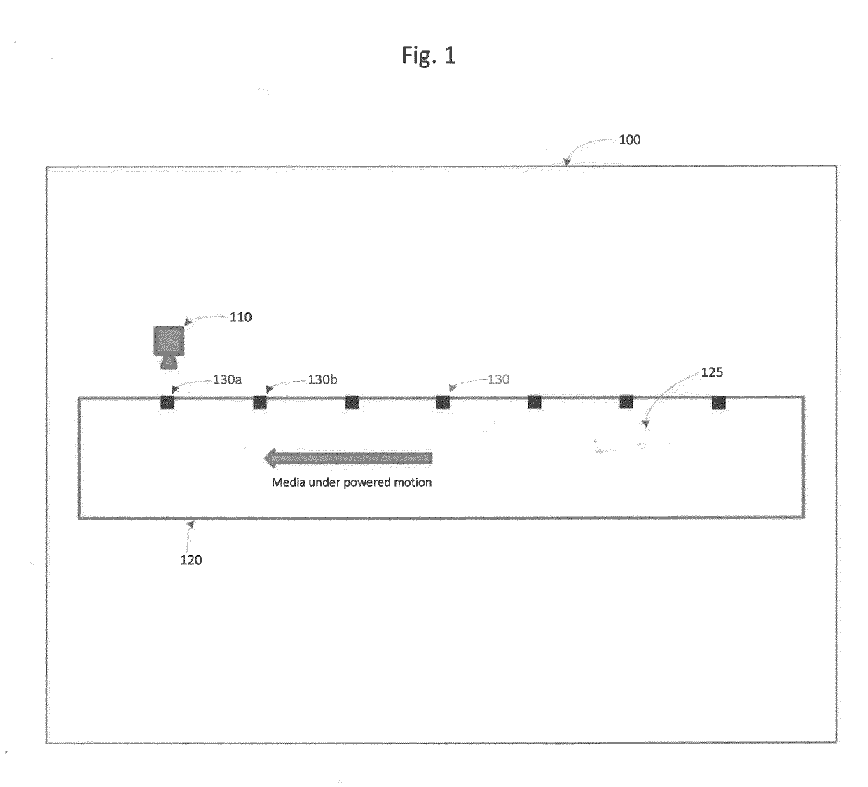

Referring to FIG. 1, a system 100 for calibrating a printing device (not shown) includes a media 120 and an attribute detector 110. As used herein, the term “media” includes, without limitation, print media or paper, for example, cut paper, continuous paper, labels, envelops and other instruments that can be fed through a printing device. As used herein, the term “printing device” includes, without limitation, a printer, a plotter or a scanner. Preferably, the printing device includes a laser printer.

Conventionally, the speed of a printing device is preset and remains constant as the media moves along the printing device. Printing devices typically include a fuser or a pair of heated rollers. The operation of the rollers is controlled by firmware or software that resides in the printing device. When the media passes through the fuser, powder in the printer's toner can melt and fuse with the fibers in the media. The fuser can then roll the media to an output tray. However, due to environmental factors, for example, the fuser may contract or expand with time. This can impact the printing speed of the printing device which may, in turn, cause the printing job or output to be inaccurate.

Alternately, other characteristics of the printing device, the media, and even environmental factors such as temperature, humidity, etc. may affect an actual printing speed. Deviations in the actual printing speed may be observed in even similar model printing devices. Accordingly, the calibrated speed of the printer may not correspond to the actual printing speed of the printing device. That is, the calibrated printing speed may not be a constant. The deviation in the calibrated and actual printing speed may be very minor. However, even such a minor or micro deviation may add up to cause inaccuracies to creep into the printing or plotting job. The distortions become particularly noticeable when the media is continuous paper or label. For instance, when the printing job involves repeatably reproducing the printed matter on several consecutive continuous sheets of papers or labels, the deviation in the calibrated and actual printing speed may cause the label to drift such that the printed output is not uniformly spaced on each continuous sheet or label. Therefore, even a slight change in the printing speed may have a detrimental impact on printing jobs that require a high degree of accuracy.

The printing of well logs, for instance, requires such a high degree of accuracy. A well log is a detailed report of a hydrocarbon-bearing geological formation that is penetrated by a wellbore. A well can include, without limitation, an oil, gas, or water production well, an injection well, or a geothermal well. Conventional well log printers are capable of several functions, including, Top of Form. Top of Form allows the printing system to calibrate itself based on specific log paper sheet size such that the printing system will allow the printing media to automatically advance to the next fold in the log paper after printing a well log. Accordingly, each log file will position correctly, beginning at the top a page. However, this does not allow an adjustment of the printing speed during its operation. It is important to obtain accurate well log data in order to effectively interpret the hydrocarbon-bearing formation. Deviations in the printed output may detrimentally impact the ability to fully exploit the oil or gas well. There is, therefore, a need for self-adjusting the speed of the printing device in order to improve the accuracy of the printing.

According to one embodiment of the invention, the speed of the printing device can be self-adjusted by using the media as a calibration instrument. The media may be provided with an attribute which may be detected by an attribute detector. The actual speed of the printing device may be adjusted based on the detected attribute.

Now referring back to FIG. 1, the media 120 may include an attribute. An attribute may be a feature of the media 120. For example, the attribute may comprise at least two or more marks or markings 130. The attribute may also comprise any other feature (for example, a repeating pattern) or a physical characteristic of the media (for example, the length of the media) that can be detected by the attribute detector 110. A person skilled in the art may be able to determine appropriate media attributes that can facilitate automatic calibration of the printing device based on the present disclosure.

The markings 130 may be created or located on both a firstsurface 125 and a second surface (not shown). The first surface 125 may be a lower surface or a surface opposite the surface on which the printed matter is printed or plotted. The markings 130 may be positioned substantially near one margin of the media 120. The markings 130 may be located on at least a first surface 125 of the media 120. The markings 130 may be spaced at a known distance from each other. At least a first marking 130a and a second marking 130b may be spaced equidistant from each other. The location of at least the first marking 130a and the second marking 130b may be fixed and predetermined. In one or more embodiments, each of the markings 130 may be spaced equidistant from a succeeding marking 130 and from each other. Alternately, the first marking 130a and the second marking 130b may be spaced apart at a distance that ensures an “ideal” travel time between first marking 130a and the second marking 130b can be achieved at a desired printing speed. The ideal travel time associated with the desired printing speed can be predetermined. The desired printing speed may be predetermined and it may correspond to the calibrated printing speed. The desired printing speed may be adjusted depending on the printing job or printing output, the media and the printing device.

The attribute detector 110 may be implemented as a dynamic device. That is, the attribute detector 110 may detect the markings 130 on a real time basis as the media passes through the printing device's media path. The attribute detector 110 may be implemented as a standalone device that can be configured to communicate with the printing device. The communication may involve alerting the printing device's firmware when the printing speed does not meet a selected or predetermined threshold printing speed. The attribute detector 110 may comprise a sensor (not shown) for detecting the markings 130. In another embodiment, the attribute detector 110 may also be embedded within the printing device. For instance, the printing device may comprise an attribute detector 110 module.

The attribute detector 110 may include a computer processor and a memory. Information on the printing device, the media 120, the attribute (for example, the first marking 130a and the second marking 130b) to be detected, the desired printing speed, the ideal travel time between the first marking 130a and the second marking 130b, etc. may be stored in the memory. The attribute detector 110 can monitor the media 120 as it passes through the printing device's media path. The attribute detector 110 can monitor or detect the actual time required to travel between the first marking 130a and the second marking 130b. Since the distance between the first marking 130a and the second marking 130b is already known, upon detection of the actual time required to travel between the first marking 130a and the second marking 130b, the processor can calculate the actual printing speed of the printing device.

The processor can be configured to automatically compare the actual printing speed with the desired printing speed. If the actual printing speed exceeds or is below the desired printing speed, the attribute detector 110 can transmit this comparison information to the firmware that controls the fuser. The firmware can include computer program instructions to adjust the printing speed of the printing device such that the adjusted printing speed is substantially equal to the desired printing speed. The adjustment of the printing speed may occur in small increments until the actual printing speed substantially matches the desired printing speed. Alternately, in another embodiment, the attribute detector 110 can be configured to communicate directly with the fuser and, thereby, adjust the printing speed of the printing device.

In one or more embodiments, the attribute detector 110 may include an user-friendly control panel that provides real time information on the actual printing speed. The one or more embodiments of the invention may be easily implemented and may require minimal user assistance. The attribute detector 110 may be conveniently integrated with well log printing applications or any other printing applications.

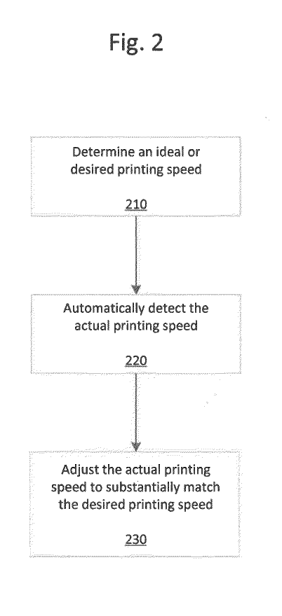

Referring now to FIG. 2, in another embodiment, a computer-implemented method for automatically calibrating a printing device is disclosed. An ideal or desired printing speed is initially determined 210. The desired printing speed may be determined prior to, during or after the media is fed through the printing device. The actual printing speed may then be automatically detected 220. Detecting the actual printing speed may involve automatically detecting an attribute of the media as the media is moved through a media path of the printing device. The method can further include adjusting the printing speed of the printing device to substantially match the desired printing speed 230. The adjustment of the actual printing speed may be based on the detected media attribute.

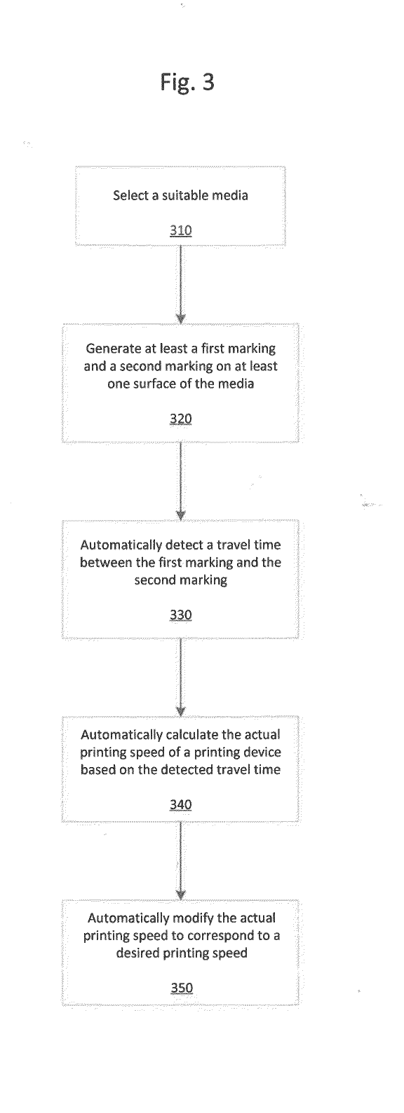

Referring to FIG. 3, the method for adjusting the actual printing speed involves selecting a suitable media 310. The media may include labels or continuous sheet paper. According to one or more embodiments, the media may have a durability, smoothness and preciseness that is ideal for high speed continuous printing. At least a first marking and a second marking may be generated on at least a first surface of the media 320. The media may be pre-configured with the desired attributes. Alternately, the attributes may be imprinted or burned onto a surface of the media. The media can be inserted into the printing device. The media may be pulled into the printing device and straightened as it is loaded.

A desired printing speed may be determined prior to passing the media through the media path of the printing device. Alternately, the printing speed may be determined during or after the media is fed through the printing device. The method further involves automatically detecting the travel time between the first marking and the second marking 330. The method further involves automatically determining or calculating an actual printing speed of the printing device 340. The actual printing speed may correspond to an actual time required to travel between, for example, the first marking and the second marking. The method further involves comparing the actual printing speed with the desired printing speed. The actual printing speed of the printing device can be incrementally modified until it substantially matches the desired printing speed 350. In this manner, the speed of the printing device can be self-adjusted so that each sheet of media goes through the printing device at an uniform speed.

The automatic speed adjustment can occur in real time. That is, the printing device can self-adjust its speed when it is in operation as the media passes through the printing device's media path. For the purposes of this description, the term “real time” shall include any time frame of sufficiently short duration so as to adjust the speed of the printing device. The term “real time” shall also include “near real time” or “substantially in real time”—this may include within a few seconds to less than a minute in certain printing devices.

An attribute detector 110 may be implemented as a standalone device that does not communicate with the printing device. In this embodiment, the attribute detector 110 may include a control panel (not shown) that can display the actual printing speed of the media 120. If needed, the user of the printing device may be able to manually configure the speed of the printing device to match the desired printing speed.

The one or more embodiments of the invention can be used in any industry where it is desirable to move the media at a desired speed.

As used herein, the words “comprise,” “have,” “include,” and all grammatical variations thereof are each intended to have an open, non-limiting meaning that does not exclude additional elements or steps. It should be understood that, as used herein, “first,” “second,” and “upper” and “lower” etc. are arbitrarily assigned and are merely intended to differentiate between two or more markings, surfaces of the media etc., on the as the case may be, and does not indicate any particular number, orientation or sequence. Furthermore, it is to be understood that the mere use of the term “first” does not require that there be any “second,” and the mere use of the term “second” does not require that there be any “third,” etc.

It is submitted that the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present invention. While the system, computer program product and methods are described in terms of “comprising,” “containing,” or “including” various components or steps, the system, computer program product and methods also can “consist essentially of” or “consist of” the various components and steps.

The terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

1. A computer-implemented method for automatically calibrating a printing device, the method being performed by a computer processor connected to a memory, the method comprising:
automatically detecting an attribute of a media as the media is moved through a media path of the printing device; and
adjusting the printing speed of the printing device in dependence on the detected attribute,
wherein a desired printing speed is determined prior to, during or after the media is fed through the printing device.

2. The method according to claim 1, wherein the attribute comprises a plurality of predetermined markings, wherein each of the markings is located on a surface of the media.

3. The method according to claim 1, further comprising generating the plurality of predetermined markings on the surface of the media, wherein at least a first predetermined marking and a second predetermined marking are spaced apart at a preselected interval.

4. The method according to claim 3, further comprising processing, in the processor, an actual printing speed of the printing device.

5. The method according to claim 4, wherein processing the actual printing speed comprises determining a time required to travel between the first predetermined marking and the second predetermined marking.

6. The method according to claim 5, further comprising comparing, in the processor, the actual printing speed and the desired printing speed.

7. The method according to claim 6, wherein the actual printing speed of the printing device is incrementally modified until it substantially matches the desired printing speed.

8. (canceled)

9. The method according to claim 4, further comprising automating, by the processor, the adjusting the actual printing speed of the printing device.

10. A non-transitory computer-readable storage medium storing computer program instructions for calibrating a printing device comprising:
computer program instructions for automatically detecting an attribute of a media as the media is moved through the printing device; and
computer program instructions for adjusting the printing speed of the printing device in dependence on the detected attribute,
wherein a desired printing speed is determined prior to, during or after the media is fed through the printing device.

11. The computer-readable storage medium according to claim 10, wherein the attribute comprises a plurality of predetermined markings, wherein each of the markings is located on a surface of the media.

12. The computer-readable storage medium according to claim 11, further comprising computer program instructions for spacing at least a first predetermined marking and a second predetermined marking at a preselected interval.

13. The computer-readable storage medium according to claim 11, further comprising computer program instructions for processing an actual printing speed of the printing device, wherein the actual printing speed corresponds to an actual time required to travel between the first predetermined marking and the second predetermined marking.

14. The computer-readable storage medium according to claim 13, further comprising computer program instructions for comparing the actual printing speed and the desired printing speed.

15. The computer-readable storage medium according to claim 14, further comprising computer program instructions for incrementally modifying the actual printing speed of the printing device until it substantially matches the desired printing speed.

16. A system for calibrating a printing device comprising:
a media, wherein the media comprises at least one attribute; and
an attribute detector, wherein the attribute detector comprises
a processor; and
a memory communicatively linked to the processor, the memory storing computer program instructions executable by the processor comprising:
computer program instructions for automatically detecting the attribute of the media as the media is moved through the printing device; and
computer program instructions for adjusting the printing speed of the printing device in dependence on the detected attribute,
wherein a desired printing speed is determined prior to, during or after the media is fed through the printing device.

17. The attribute detector according to claim 16, wherein the attribute comprises a plurality of predetermined markings, wherein each of the markings is located on a surface of the media.

18. The attribute detector according to claim 16, further comprising computer program instructions for processing an actual printing speed of the printing device, wherein the actual printing speed corresponds to an actual time required to travel between at least a first predetermined marking and a second predetermined marking.

19. The attribute detector according to claim 18, further comprising computer program instructions for comparing the actual printing speed and the desired printing speed.

20. The attribute detector according to claim 19, further comprising computer program instructions for incrementally modifying the actual printing speed of the printing device until it substantially matches the desired printing speed.
